(19) United States
(12) Patent Application Publication
(10) Pub. No.: US 2024/0411797 A1
(43) Pub. Date: Dec. 12, 2024

(54) USING AN ONTOLOGICALLY TYPED GRAPH TO ENHANCE THE ACCURACY OF A LARGE LANGUAGE MODEL BASED ANALYSIS SYSTEM

(71) Applicant: Microsoft Technology Licensing, LLC, Redmond, WA (US)

(72) Inventors: William BLUM, Bellevue, WA (US); Sébastien Martin DIOTTE, Gatineau (CA); Martin Jean FONTAINE, Gatineau (CA); Edward Richard SOBEY, Cheltenham (GB); Tal Joseph MAOR, Seattle, WA (US); Shruti RANJIT, Ajax (CA); Richard DONAGHY, Cheltenham (GB); Michal EZRETS GIL, Arad (IL); Cory James CLOWES, Ottawa (CA); Emily Maria MAKEDON, Chicago, IL (US); Ross Kingsley WILYMAN, Churchdown (GB)

(21) Appl. No.: 18/208,840

(22) Filed: Jun. 12, 2023

(51) Int. Cl. G06F 16/36; G06F 16/332; G06F 16/338; G06F 16/35

(52) U.S. Cl. CPC G06F 16/367; G06F 16/332; G06F 16/338; G06F 16/355

(57) ABSTRACT

A large language model consumes example query expressions, including a data access function, a data analytics function, or a data enrichment function. The large language model receives a centrally managed ontology. The large language model uses the centrally managed ontology, and identifies skill ontological types from the example query expressions. The skill ontological types are normalized (to the centrally managed ontology) input arguments types or structured output. The large language model receives context for an investigation and identifies a context ontological type. The large language model receives received skills, based on correlation between a skill ontological type, having connections in a graph to the received skills, and the context ontological type. The large language model produces and provides an indication of a suggested skill for the investigation.

### BACKGROUND

Analysts, investigators, and researchers often encounter complicated situations that necessitate gathering evidence from various sources and choosing suitable analysis methods. To facilitate these tasks, large language models (LLMs) are increasingly employed to provide results based on specified investigation goals. Nonetheless, LLMs have certain limitations due to their training on publicly available data at a specific point in time, resulting in a lack of recent public and private contextual information. To address these shortcomings, additional functions called “skills” are used in conjunction with LLMs during investigations.

The ever-expanding data and information landscape, along with the continuous development of new analytics, make it increasingly challenging for analysts to stay updated on the variety of skills available. Skills consist of data access, analytics, and enrichment functions that accept input arguments and generate structured outputs. Examples of skills include database queries, search engine searches, view and table generation operations, API calls, and other similar operations that produce structured outputs.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In one embodiment, a large language model system collects multiple example query expressions from various locations across a network. Each different query expression contains at least one different data access, analytics or enrichment function. The system obtains a centrally managed ontology and employs it to identify skill ontological types within the query expressions. These types relate to input arguments or structured outputs of skills and are standardized according to the centrally managed ontology.

The system acquires investigation context and extracts ontological types from it. Subsequently, it retrieves skills based on correlations between skill ontological types linked to a graph and the ontological types within the context. As a result, the system generates and delivers a suggested skill for the investigation via a network connection.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates annotated skills created from example query expressions by an LLM system;

FIG. 2 illustrates a graph generator generating an ontologically typed graph from annotated skills;

FIG. 3 illustrates the ontologically typed graph;

FIG. 4A illustrates a preliminary flow for creating a pruned graph;

FIG. 4B illustrates an iterative flow for creating a pruned graph;

FIG. 5 illustrates a method of obtaining ontological types associated with skills from an LLM system and creating an ontologically typed graph;

FIG. 6 illustrates a method of producing and providing an indication of suggested skills for an investigation;

FIG. 7A illustrates another example of an ontologically typed graph;

FIG. 7B illustrates a path on the ontologically typed graph for identifying skills to indicate for a combined query; and

FIG. 8 illustrates an example computer system that can be configured to perform any of the disclosed operations.

### DETAILED DESCRIPTION

Embodiments illustrated herein use an ontologically typed graph of skills to enhance the accuracy and efficiency of a large language model (LLM) system based skill recommendation system. In particular, embodiments supplement the LLM system by identifying example query expressions, which may be query expressions input by users, query expressions existing on the Internet, or query expressions found in other locations. Example query expressions are database queries, search engine searches, view generation operations, table generation operations, API calls, etc. having specific arguments in the example query expressions. In general, an example query expression has a specific data access function, a data analytics function, or a data enrichment function. For example, a user may share a specific query, with specific information, as an example of a query that has worked for the user in the past. Alternatively, a system may collect queries input by users.

A computing system also provides a centrally managed ontology, along with a schema for data in the example query expressions. The schema may be obtained from a datastore against which the example query expression is run. Input and output types in the example query expressions are normalized to ontological types in the centrally managed ontology and used to create annotated skills (sometimes referred to herein simply as “skills”). Annotated skills are genericized versions of example query expressions that can be used generally by an investigator. That is, specific example query expressions can be genericized for general use.

A graph generator creates a graph connecting the annotated skills together through the ontological types. Thus, two different skills being associated with the same ontological types are connected through the ontological type in the graph. As noted, the ontological types are related to inputs into the skills and/or to the structured data produced from invoking a skill. In particular, inputs and outputs are adequately represented with the ontological type system. For example, assume a certain skill “getAssociatedDomains(IPAddress):DomainName[ ]”, returns the domain names associated with a given IP address. In that example, a node would be created for the skill “getAssociatedDomains”, and would be linked with two ontological type nodes, namely “IPAddress” and “DomainName”. Other skills associated with one of the same ontological types is connected to the certain skill, through the ontological type.

If the graph is appropriately sized (i.e., it will not cause an input to an LLM system to exceed the token budget for the LLM system) it can be passed in a prompt of an LLM system along, with a textual investigation context and investigation goal, to the LLM system, which causes the LLM system to provide a skill recommendation.

However, inputting a large number of skills into a prompt and passing the skills to an LLM system has several challenges. For example, often the token budget (i.e., a limit on the amount of information that can be entered into a prompt) for the LLM system is not sufficient to enter all of the skills that are relevant to a particular investigation. Another challenge relates to limitations of the LLM system, whereby the LLM system becomes confused due to having too many choices. In particular, so-called model hallucinations (i.e., AI responses that are not justified by training data) and confusion will increase. Another challenge relates to that the AI model probability of proposing an inadequate skill increases with large numbers of skills. An inadequate skill suggestion includes selecting a skill with argument types that are incompatible with contextual types.

Thus, some embodiments, “prune” the ontologically typed graph of skills to select relevant sets of skills to be input in a prompt. In particular, by the skills being connected using ontological types, ontological types for current context and/or investigation goals can be identified to select an appropriate portion of the graph to input into a prompt.

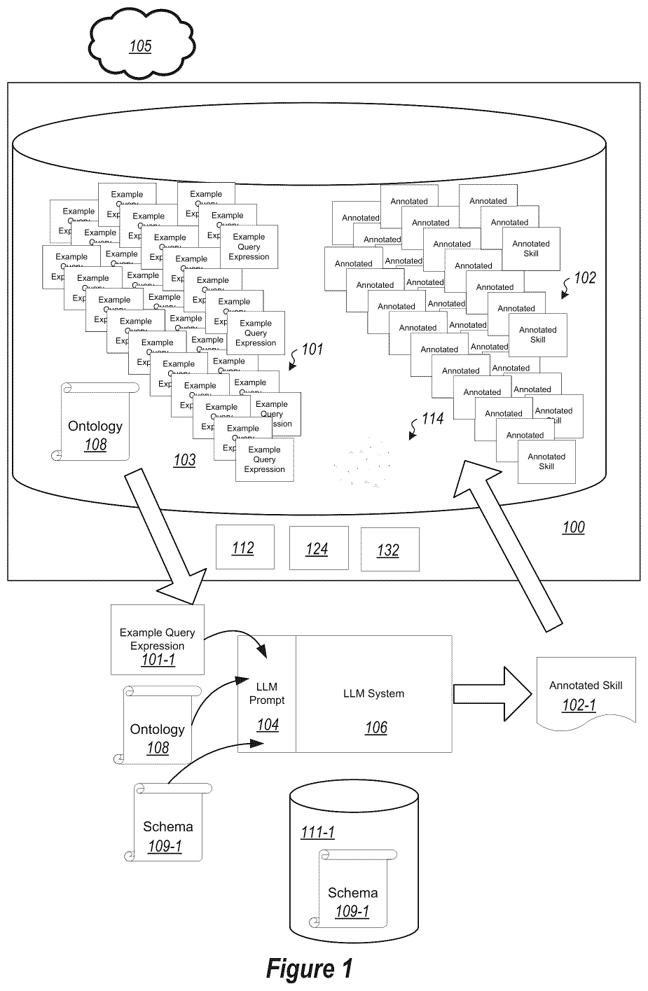

Additional details are now illustrated. Referring now to FIG. 1, a set of example query expressions 101 is illustrated in a datastore 103 of a computing system 100. The example query expressions in the set of example query expressions 101 may be collected in a number of different fashions. For example, the computing system 100 may include Internet or network crawling functionality to search out query expressions that have been proposed by various users. For example, FIG. 1 illustrates a network 105 that is coupled through various hardware network connections to the computing system 100. The computing system 100 may search for and retrieve example query expressions that have been stored in various locations in the network 105. This allows the computing system 100 to obtain a broad spectrum of example query expressions for diverse and far reaching locations.

Alternatively, or additionally, the computing system 100 may receive user query expressions that a user manually inputs over the course of an investigation. Example query expressions typically include specific inputs for a specific situation. For example, such inputs may include a time, an IP address, a device identifier, path names, or other specific inputs. Typically a user will be connected through a network to the computing system to provide the query expressions to the computing system 100.

In particular, the computing system 100 will use various network connections to seek out example query expressions to include in the set of example query expressions 101.

An analyst may be able to generate (or have suggested to them) their own query expression similar to one of the example query expressions in the set of example query expressions 101 to perform an investigation. Rather than keeping track of all of the possible query expressions, which would be humanly impossible to even gather, let alone keep track of, their related functionality, and data types that they are useful for, the analyst may wish to use an LLM system to assist in selecting skills for the investigation. As will be illustrated below, this can be accomplished by the analyst providing current context and an investigation goal, and the computing system 100 providing skills to the LLM system. The LLM system can then suggest appropriate skills based on the current context and investigation goal.

However, rather than providing the entire set of skills, a subset of the set of skills may be provided to comply with a token budget of the LLM system and to reduce errors in skill suggestions. Thus, FIG. 1 illustrates actions that can be performed to identify ontological types associated with skills. The ontological types are used as a way to “join” or “pivot” between different skills. Note that this assumes that the LLM system is aware of and uses a centrally managed list of ontological types that have been adequately crafted for a particular domain of analysis (e.g. networking, finance, etc.). This is accomplished by the LLM system being provided with a centrally managed ontology 108 maintained by the computing system 100.

FIG. 1 illustrates that the computing system 100 selects an example query expression 101-1 from the set of example query expressions 101 and provides the example query expression 101-1 to an LLM prompt 104 of an LLM system 106. Note that the computing system 100 is external to the LLM system 106 such that the computing system 100 is coupled to the LLM system through a network connection. An example query expression either directly or indirectly provides entities (i.e., instances of ontological types) for data input into, or produced by invocation of a skill.

The computing system 100 provides an ontology 108 to the LLM prompt 104 of the LLM system 106 to help the LLM system 106 in consistently annotating a given skill. The computing system further obtains a schema 109-1 for the particular example query expression 101-1. The schema 109-1 defines how data is organized in a datastore 111-1 which the example query expression queries. The computing system can obtain the schema by communicating over a network connection with the datastore 111-1 to obtain the schema 109-1. Note that each example query expression in the set of example query expressions 101 will be associated with a particular datastore and a particular schema which may be different than those for other query expressions.

Note also that different example query expressions may have non-standard ontological entities. Embodiments illustrated herein can produce normalized ontological types from the non-standard ontological entities using the centralize ontology 108.

The computing system 100 comprises specialized software executed on hardware which selects example query expressions and accesses schemas and ontologies to provide to the LLM system 106. The LLM system 106 identifies ontological types associated with the example query expression 101-1, based on the schema 109-1 and ontology 108. As a result, the LLM system 106 produces an annotated skill 102-1 with generic ontological types which genericize the entities (i.e., specific instances of ontological types) in the example query expression 101-1 to ontological types, thereby normalizing ontological types for the skills. In particular, the ontology 108 includes all or part of the centrally managed list of ontological types such that ontological types in the annotated skill 102-1 are consistent with the centrally managed list of ontological types. For example, native ontological types source IP address, victim IP address, and target IP address may be normalized to address.

Note that the normalization takes into account data formats so that skills can be appropriately joined. In particular, the different native ontological types normalized into an ontological type that is of the type that is centrally managed, will have the same data type (i.e., integer, string, floating point, etc.) as well as the same format of data. Thus, for example, source IP address, victim IP address, and target IP address will all be numbers that are 32-bits.

In some embodiments, an adapter may be used to normalize native ontological types. For example, consider an ontology type “username”, where a native returned ontological type is named “redmond/username”. The adapter can strip “redmond” from the native returned ontological type to arrive at the “username” ontological type.

Consider the following example query expression (which in this case has specific populated input entities):

//What process created the file?
DeviceFileEvents
| where TimeGenerated >= ago(30d)
| where DeviceId == ‘26f96f104e8576d85be32d91d06e2fb988c0cd52’
| where FolderPath contains
@“C:\Users\lrodriguez\Downloads\SalesLeadsUpdate.one”
| project
TimeGenerated,ActionType,DeviceName,FolderPath,InitiatingProcessAccountDomai
n, InitiatingProcessAccountName,
InitiatingProcessFileName,InitiatingProcessIntegrityLevel,InitiatingProcessP
arentFileName
| take 100

Also, consider the following table schema:

| | |
|---|---|
| [ | { |
| | “Database”: “DB”, |
| | “Tables”: [ |
| | { |
| | “Columns”: [ |

| | |
|---|---|
| { | “Type”: “System.DateTime”, fo |

| | |
|---|---|
| “Name”: “Timestamp” | }, |

| | |
|---|---|
| { | “Type”: “System.String”, |

| | |
|---|---|
| “Name”: “AlertId” | }, |

| | |
|---|---|
| { | “Type”: “System.String”, |

| | |
|---|---|
| “Name”: “Title” | }, |

| | |
|---|---|
| { | “Type”: “System.String”, |

| | |
|---|---|
| “Name”: “Category” | }, |

| | |
|---|---|
| { | “Type”: “System.String”, |

| | |
|---|---|
| “Name”: “Severity” | }, |

| | |
|---|---|
| { | “Type”: “System.String”, |

| | |
|---|---|
| “Name”: “ServiceSource” | }, |

| | |
|---|---|
| { | “Type”: “System.String”, |

| | |
|---|---|
| “Name”: “DetectionSource” | }, |

| | |
|---|---|
| { | “Type”: “System.String”, |

| | |
|---|---|
| “Name”: “AttackTechniques” | } |

```
        ],
        “Table”: “AlertInfo”
```

And consider the following partial ontology:

ontology_entities:

| | |
|---|---|
| - | type_name: IP_ADDRESS |
| | Description: An IPV4 address |
| | examples: |
| | - 52.138.20.1 |
| | - 20.10.10.1 |
| - | type_name: DOMAIN NAME |
| | Description: An Internet domain name resolvable with DNS |
| | examples: |
| | - www.microsoft.com |
| | - azure. com |
| | - hotmail.com |
| - | type name: AZURE_APPLICATION_ID |
| | Description: A unique Application ID assigned by Azure |
| | examples: |
| | - 1a12ab12-1ab1-12ab-a12a-12abcd12345 |
| - | type_name: AZURE_TENANT_ID |
| | Description: A unique tenant ID assigned by Azure |
| | examples: |
| | - 1c98028b-a5bc-469a-91ae-c980ade7bde0 |
| - | type_name: AZURE_TENANT_ID_SCRUBBED |
| | Description: A hashed (SHA1) version of the unique tenant ID |
| | examples: |
| | - StrPII_2b22bb22-2bb2-22bb-b22b-22bbbb22222 |
| - | type_name: AZURE_SUBSCRIPTION_ID |
| | Description: A unique subscription ID assigned by Azure |
| | examples: |
| | - 5c98128b-albb-165a-91aa-c981aae7cde0 |

...

When the above example query expression, table schema, and full ontology represented partially above are provided to the LLM system 106, the LLM system produces an annotated skill as follows:
!KustoSpec

```
description: This query returns the process information that created a
file on a device
  within a given time range.
inputs:
- {name: start_date, type: datetime}
- {name: end_date, type: datetime}
- {name: device_name, ontology_type: DeviceId, type: string}
- {name: file_path, ontology_type: File, type: string}
- {name: limit, ontology_type: None, type: int}
kql: |
  DeviceFileEventsa
  | where Timestamp between (datetime({{start_date}}) ..
datetime({{end_date}}))
  | where DeviceName like ‘{{device_name}}’
  | where FolderPath contains ‘{{file_path}}’
  | project
Timestamp,ActionType,DeviceName,FolderPath,InitiatingProcessAccountDom
ain, InitiatingProcessAccountName,
InitiatingProcessFileName,InitiatingProcessIntegrityLevel,InitiatingPr
ocessParentFileName
  | take {{limit}}
name: FileCreationProcess
output: !KustoOutput
  fields:
  - !KustoOutputField {name: Timestamp, ontology_type: null, type:
datetime}
  - !KustoOutputField {name: ActionType, ontology_type: null, type:
string}
  - !KustoOutputField {name: DeviceName, ontology_type:
M365_ENDPOINT_MACHINE_ID, type: string}
  - !KustoOutputField {name: FolderPath, ontology_type: File, type:
string}
  - !KustoOutputField {name: InitiatingProcessAccountDomain,
ontology_type: DOMAIN_NAME,
    type: string}
  - !KustoOutputField {name: InitiatingProcessAccountName,
ontology_type: AAD_USER_PRINCIPAL_NAME, type: string}
  - !KustoOutputField {name: InitiatingProcessFileName, ontology_type:
File, type: string}
  - !KustoOutputField {name: InitiatingProcessIntegrityLevel,
ontology_type: null,
    type: string}
  - !KustoOutputField {name: InitiatingProcessParentFileName,
ontology_type: File,
    type: string}
  format: KqlQueryResults
  type: DataTable
product: mde
```

Careful examination of this annotated skill shows generic ontological types identified for inputs and outputs of the “DeviceFileEvents” skill.

This process is repeated for other skills data sources in the set of example query expressions 101 using the same ontology 108 and appropriate schemas so as to create annotated skills for example query expressions in the set of example query expressions 101, thus creating the set of skills 102. Each different annotated skill corresponds to a different example query expression. The set of skills 102 are then stored at the computing system 100 for later use in generating skill recommendations for an investigation.

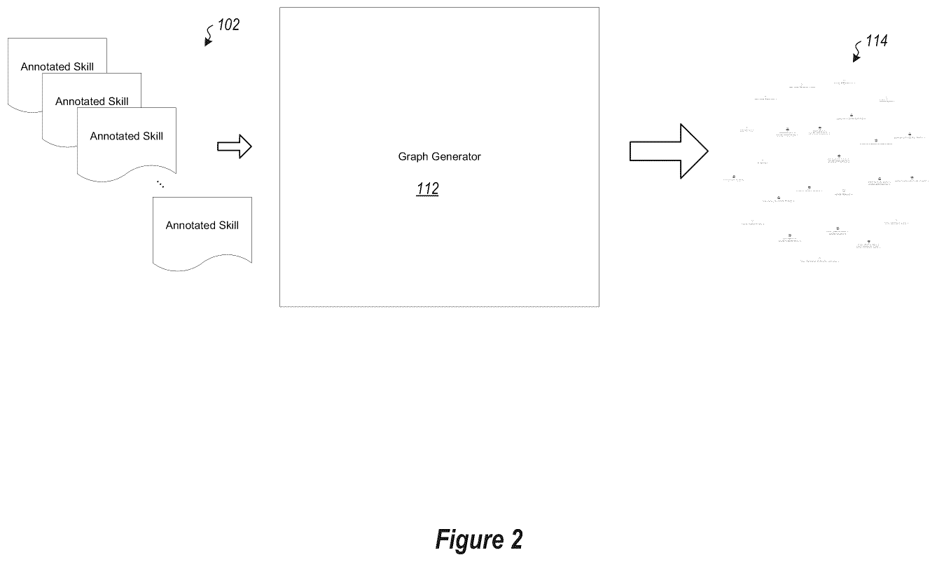

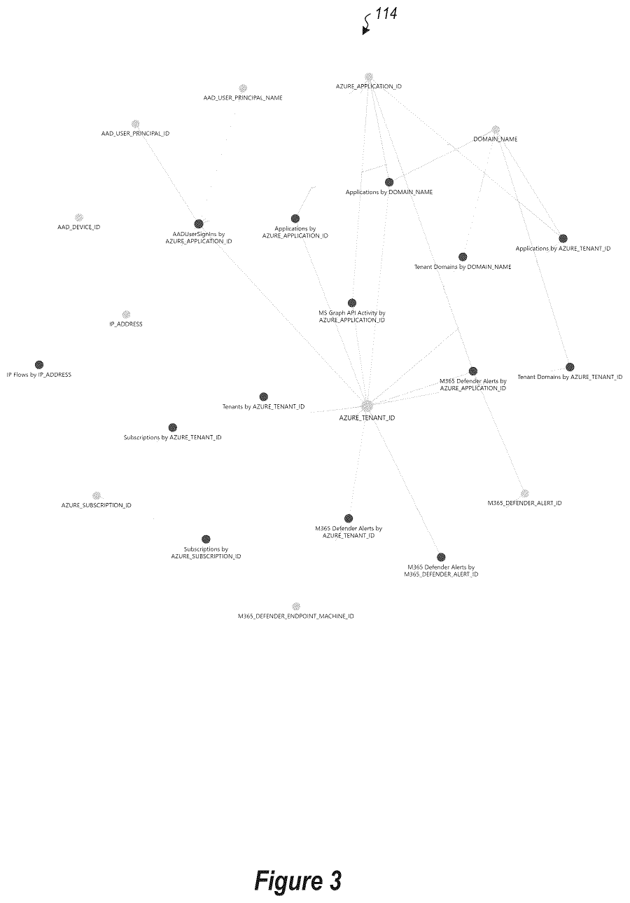

Referring now to FIG. 2, a graph generator 112, which may be part of the computing system 100, receives the set of skills 102 corresponding to the set of example query expressions 101. Note that each example query expression is used to create a different corresponding skill, such that different example query expressions are correlated to different corresponding skills. The graph generator 112 generates an ontologically typed graph 114, which can be stored at the computing system 100. The ontologically typed graph 114 connects skills to each other using in-common ontological types from the set of skills 102. Examples of this are illustrated in FIG. 3, which shows an enlarged version of the ontologically typed graph 114. For example, FIG. 3 illustrates that the skills “M365 Defender Alerts by M365_DEFENDER_ALERT_ID”, “M365 Defender Alerts by AZURE_TENANT_ID”, and “M365 Defender Alerts by M365_AZURE_APPLICATION_ID”, are all linked through the ontological type M365_DEFENDER_ALERT_ID in-common to all three skills.

As noted above, passing all known skills to an LLM system may not be feasible due to token budget constraints and/or increased likelihood of LLM system recommendation inaccuracies. Some embodiments address these limitations by pruning the ontologically typed graph 114 to provide only a limited portion of the graph 114 to the LLM system 106 at any given time for analysis.

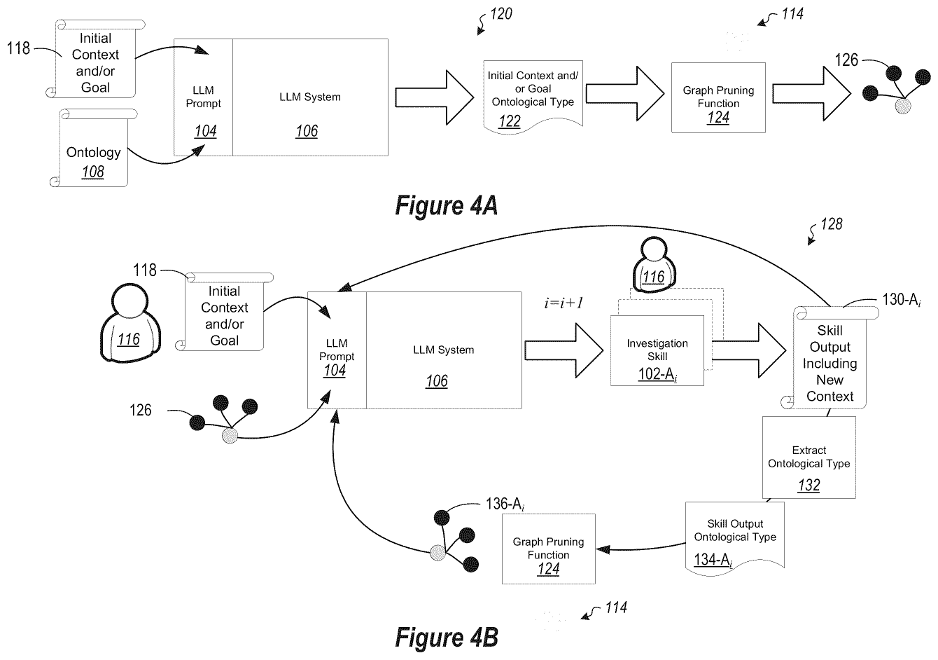

Referring now to FIGS. 4A and 4B, examples of how a limited portion of the graph 114 can be provided to the LLM system 106 to suggest skills to an analyst is illustrated. FIG. 4A illustrates that an analyst 116 (or other agent) provides an initial context and/or goal 118 to an LLM prompt 104 of the LLM system 106. Attention is first directed to the preliminary flow 120 shown in FIG. 4A. In the preliminary flow 120, the computing system 100 provides the ontology 108 to the LLM prompt 104. Instructions are provided by the computing system in the LLM prompt 104 to extract initial context and/or goal ontological types. Note that the computing system 100 is coupled to the LLM system 106 over a network connection to allow the computing system to provide ontology 108 and the instructions. The LLM system 106 extracts the initial context and/or goal ontological types 122 using the ontology 108. The LLM system 106 provides the initial context and/or goal ontological types to the computing system 100 over a network connection. Given these initial context and goal ontological types 122, the graph pruning function 124, implemented at the computing system 100, performs graph pruning. In particular, the graph pruning function 124 receives the ontologically typed graph 114 along with the initial context and/or goal ontological types 122. Because the same ontology 108 is used in creating the initial context and/or goal ontological types 122 as was used to initially create the ontologically typed graph 114 as illustrated in FIG. 2, the initial context and/or goal ontological types 122 match ontological types in the ontologically typed graph 114. Graph pruning by the graph pruning function 124 can therefore be performed by identifying skills in the ontologically typed graph 114 that are connected through an ontological type node in-common with each of the connected skills. Thus, for example, if the initial context and/or goal ontological types 122 includes the ontological type “M365_DEFENDER_ALERT_ID”, then the graph pruning function 124 can identify “M365 Defender Alerts by M365_DEFENDER_ALERT_ID”, “M365 Defender Alerts by AZURE_TENANT_ID”, and “M365 Defender Alerts by M365_AZURE_APPLICATION_ID” to be included in the initial pruning to pruned graph 126.

Note that the graph pruning function 124 may be implemented in a number of different fashions. For example, the graph pruning function 124 may be implemented by using functionality of the LLM system 106 itself. Alternatively, or additionally, the graph pruning function 124 may be implemented with specialized software implemented on hardware at the computing system 100 to implement the graph pruning function according to specific programmatic rules.

Note that the initial context and/or goal ontological types 122 may include several different ontological types, and thus the various portions of the ontologically typed graph 114 including skill nodes coupled to the ontological types in the initial context and/or goal ontological types 122 will be included in the initial pruned graph 126. Note that in this context, the initial pruned graph 126 may include a plurality of different non-interconnected graphs. Alternatively, or additionally, the initial pruned graph 126 may be constructed to include skill nodes coupled to the initial context and/or goal ontological types 122, as well as additional ontological type nodes and/or skill nodes to allow otherwise disconnected sub graphs to be connected in the initial pruned graph 126.

Attention is now directed to the recursive flow 128 illustrated in FIG. 4B. The recursive flow 128 is performed until an investigation is complete. This may be determined by the analyst 116 or automatically by the LLM system 106 determining that skill invocations will not yield additional results.

The recursive flow 128 illustrates that the analyst 116 provides the initial context and/or goal 118 to the LLM prompt 104. Additionally, the graph pruning function 124 provides the initial pruned graph 126 to the LLM prompt 104. The LLM system 106 uses the information in the LLM prompt 104 to identify an investigation skill 102-Aᵢ which is an instance of an annotated skill with arguments specific to a current investigation as determined by the LLM system 106 using the initial context and/or goal. The analyst 116 then causes the investigation skill 102-Aᵢ to be invoked. Typically, this occurs by interaction with the computing system 100 which will perform queries specified in the investigation skill 102-Aᵢ. The analyst 116 invoking an investigation skill produces output including new context 130-Aᵢ as illustrated in FIG. 4B. This may be provided to the computing system 100 over a network connection.

FIG. 4B illustrates an extract ontological type function 132 included in the computing system 100. The extract ontological type function 132 receives as input the new context 130-Aᵢ. The extract ontological type function 132 may be implemented in a fashion similar to the preliminary flow 120. That is, the LLM system 106 may receive the new context 130-Aᵢ and the schema and/or ontology 108 to produce the skill output ontological type 134-Ai, which is a context ontological type. With new ontological type 134-Aᵢ in hand, the graph pruning function 124, once again, performs graph pruning. Graph pruning can be performed in a fashion similar to that described above in the preliminary flow 120. In particular, as illustrated, the graph pruning function 124 receives the ontologically typed graph 114 along with the skill output ontological type 134-Ai, which the graph pruning function 124 uses to produce a pruned graph 136-Aᵢ.

The graph pruning function 124 provides the pruned graph 136-Aᵢ to the LLM prompt 104. The LLM prompt 104 also receives the skill output including new context 130-Aᵢ. The LLM system 106 uses the pruned graph 136-Aᵢ, (including its structure) and the skill output including new context 130-Aᵢ, and goal information to identify an investigation skill 102-Aᵢ+ to the analyst 116, by providing the investigation skill 102-Aᵢ₊₁ to the computing system, where the analyst 116 can interact with the computing system 100 to cause the investigation skill 102-Aᵢ₊₁ to be invoked. As noted, the looping processes shown repeat until an investigation is completed.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

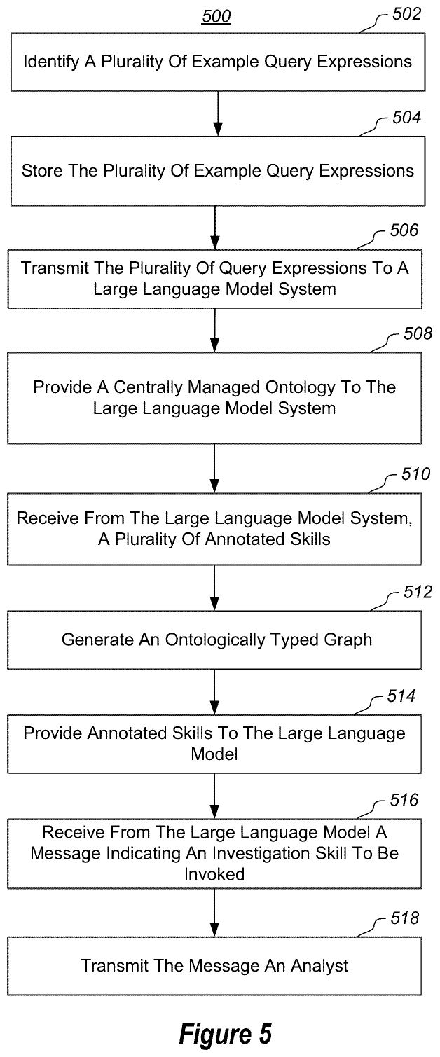

Referring now to FIG. 5, a method 500 is illustrated. Method 500 includes using network crawling to identify a plurality of example query expressions (act 502). The example query expressions are stored at various different locations on a network. The example query expressions each have their own specific data access function, a specific data analytics function, or a specific data enrichment function, having each their own specific arguments. That is, the specific arguments are ontological entities, which are instances of ontological types.

Method 500 further includes storing the plurality of example query expressions in storage at the computing system (act 504).

Method 500 further includes transmitting, over a network connection the example query expressions to a large language model system (act 506).

Method 500 further includes providing over the network connection a centrally managed ontology to the large language model system (act 508).

Method 500 further includes receiving, over the network connection, from the large language model system, a plurality of annotated skills (act 510). An annotated skill is a genericized version of an example query expression in the plurality of example query expressions. A different annotated skill is a different genericized version of a different example query expression. An annotated skill includes skill ontological types genericized from entities of an example query expressions. The skill ontological types are related to at least one of input arguments to annotated skills or structured outputs of annotated skills. The skill ontological types are normalized to the centrally managed ontology.

Method 500 further includes using the skill ontological types, storing an ontologically typed graph (act 512). The graph has skills in the plurality of skills coupled to each other through in-common, normalized, ontological types.

Method 500 further includes providing, over the network connection, at least a portion of the plurality of the annotated skills in the ontologically typed graph to the large language model system (514).

Method 500 further includes receiving, over the network connection, from the large language model system a message indicating an investigation skill to be invoked (act 516).

Method 500 further includes automatically transmitting, over the network connection, the message to an analyst (act 520)

The method 500 may further includes providing context to the large language model system. For example, providing context to the large language model system may include providing an initial context and investigation goal to the large language model system. Some embodiments may further include receiving from the large language model system a context ontological type. The context ontological type is normalized to the centrally managed ontology. Embodiments may include using the context ontological type and pruning the ontologically typed graph to store a pruned graph. In some such embodiments, embodiments include providing the pruned graph to the large language model system and receiving from the large language model system a recommendation of a skill to invoke.

Note that some embodiments may further include invoking a skill. In some such embodiments, providing context to the large language model system includes providing a context created as a result of invoking the skill.

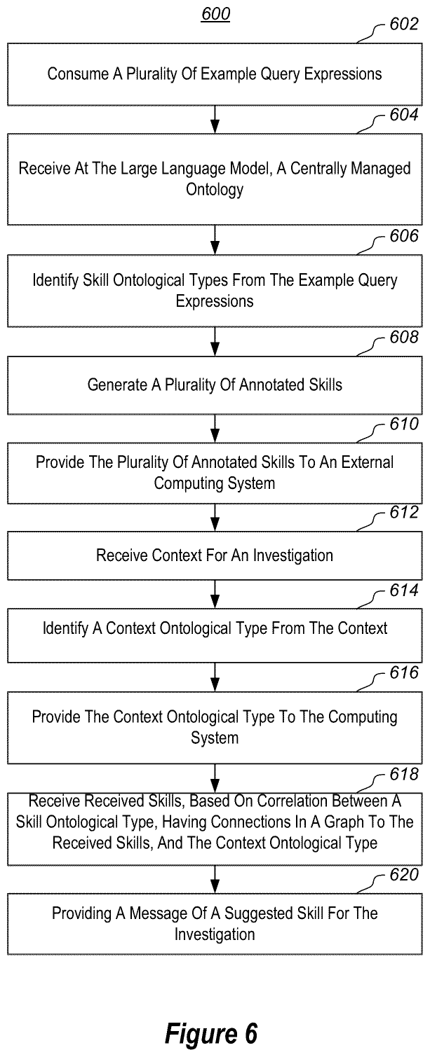

Referring now to FIG. 6, a method 600 is illustrated. The method 600 includes, at a large language model system, consuming a plurality of example query expressions (act 602). Skills in the plurality of skills includes at least one of their own specific data access function, specific data analytics function, or specific data enrichment function. Example query expressions have each their own specific arguments (i.e., ontological entities).

The method 600 further includes receiving at the large language model system, a centrally managed ontology (act 604).

The method 600 further includes the large language model system identifying skill ontological types from the example query expressions (act 606). The skill ontological types are related to at least one of input arguments to a given example query expression or structured output of the given example query expression. The skill ontological types are normalized to the centrally managed ontology, and genericized.

The method 600 further includes the large language model system generating a plurality of annotated skills (act 608). Annotated skills in the plurality of annotated skills are genericized versions of example query expressions in the plurality of example query expressions. The annotated skills include skill ontological types genericized from corresponding example query expressions.

The method 600 further includes the large language model system providing the plurality of annotated skills, over a network connection, to an external computing system (act 610)

The method 600 further includes the large language model system receiving context for an investigation (act 612). For example, FIGS. 4A and 4B illustrate that context may be provided in initial context and/or goal 118 provided to the LLM system 106. Alternatively, context may be included in skill output including new context 130-Aᵢ.

The method 600 further includes the large language model system, using the trained model, identifying a context ontological type from the context (act 614). For example, initial context and/or goal ontological type 122 is produced. Or, as illustrated at 132, skill output ontological type 134-Aᵢ is produced.

Method 600 further includes the large language model providing the context ontological type to the computing system, over the network connection (616).

The method 600 further includes the large language model system receiving, from the plurality of annotated skills, over the network, from the computing system, received skills, based on correlation between a skill ontological type, having connections in a graph to the received skills, and the context ontological type (act 618). For example, as illustrated above, the graph 114 is pruned. Skills in a pruned graph can be provided to the LLM system 106. These skills can be provided as part of a pruned graph. Alternatively, the skills may be provided from the pruned graph.

As a result, the method 600 further includes the large language model system, using the trained model, producing and providing message of a suggested skill for the investigation (act 620). For example, as illustrated in FIG. 4B, the skill 102-Aᵣ is recommended to an agent for invocation.

The method 600 may be practiced where receiving context for the investigation; identifying the context ontological type from the context; receiving received skills; and providing an indication of suggested skills for the investigation are performed recursively. As noted previously, this may be performed until an investigation is completed.

The method 600 may further include the large language model system receiving an investigation goal. In this example, providing the indication of the suggested skill for the investigation is performed using the investigation goal.

The method 600 may be practiced where at least one of the plurality of example query expressions is configured to generate a log. Alternatively or additionally, the method 600 may be practiced where at least one of the plurality of example query expressions is configured to generate a table resulting from executing a query using a skill. Alternatively or additionally, the method 600 may be practiced where at least one of the plurality of example query expressions is configured to generate a database view resulting from executing a query using a skill. Alternatively or additionally, the method 600 may be practiced where at least one of the plurality of example query expressions is configured to generate data resulting from invoking an API skill.

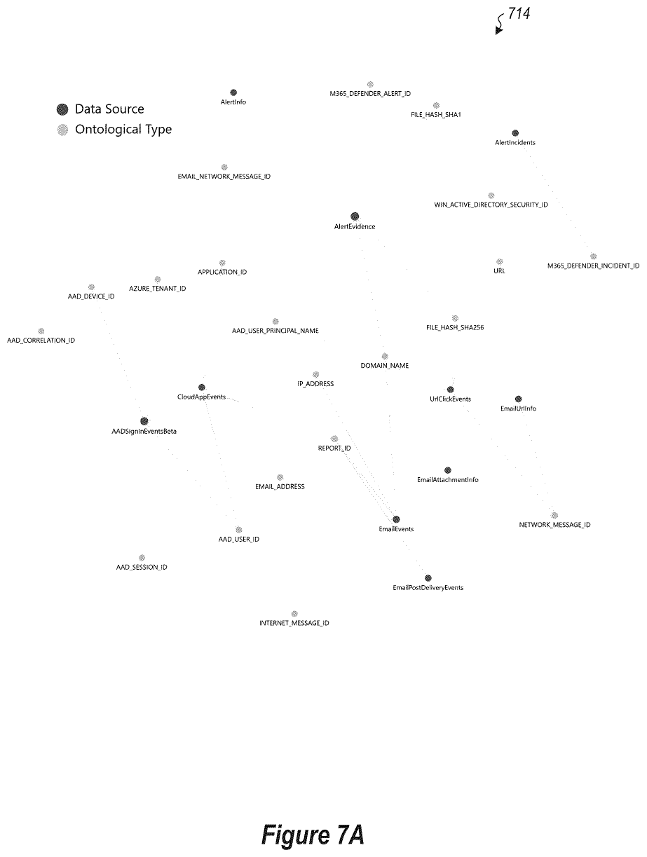

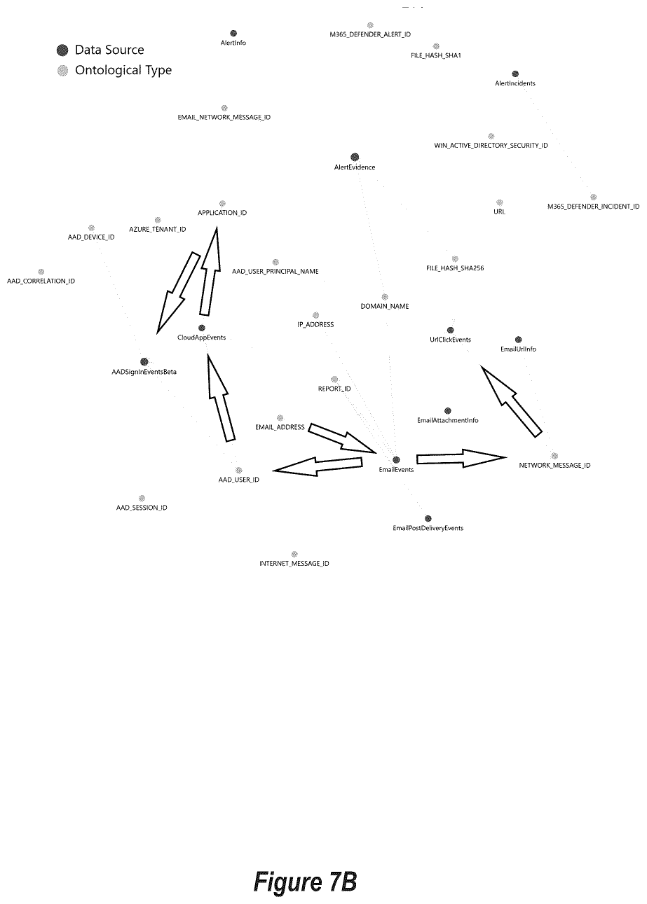

The method 600 may be practiced where the plurality of example query expressions providing an indication of the suggested skill for the investigation comprises providing an indication of a combined query comprising a plurality of skills invoked together. An example of this is illustrated in FIGS. 7A and 7B. FIG. 7A illustrates a graph 714. The graph 714 may be an example of a pruned graph provided to an LLM system. Additionally, the following statement may be entered into an LLM Prompt: “Given the graph above, generate a KQL query to find the ADD Sign-In Events related to the application that users might have consented and that was offered via a URL contained in an Email sent by the given {{EMAIL_ADDRESS}}”. The LLM system uses the graph to identify the path (and the connected skills) illustrated in FIG. 7B. The LLM system then generates the following combined query which can be invoked together, sequentially, to perform the desired investigation:

```
EmailEvents
| where Timestamp > ago(30d) and isnotempty(RecipientObjectId)
and SenderMailFromAddress == “<sample email address>”
| join kind=inner
    (UrlClickEvents | where IsClickedThrough)
  on NetworkMessageId
| join kind=inner
    (CloudAppEvents | where Timestamp > ago(30d) and ActionType
contains “Consent to application”)
  on $left.RecipientObjectId == $right.AccountObjectId
| join kind=inner
    (AADSignInEventsBeta | where Timestamp > ago(30d))
  on $left.ObjectId == $right.ApplicationId
```

The method 600 may be practiced where the plurality of example query expressions identifying the skill ontological types or the context ontological type comprises adapting native ontological types to normalize the skill ontological types to the centrally managed ontology.

The method 600 may further include performing a shortest path analysis. In some such embodiments, providing an indication of the suggested skill for the investigation comprises providing an indication of a skills identified in the shortest path analysis.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

### Example Computer/Computer Systems

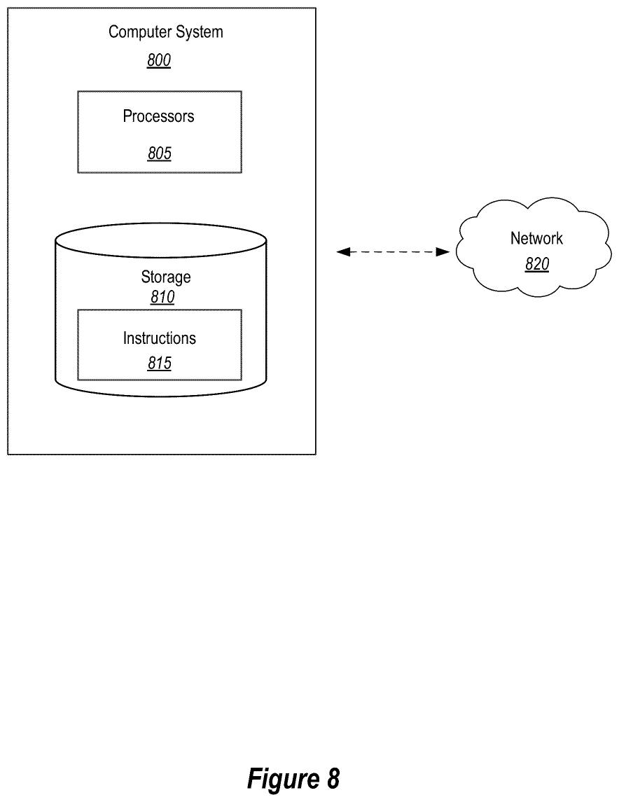

Attention will now be directed to FIG. 8 which illustrates an example computer system 800 that may include and/or be used to perform any of the operations described herein. Computer system 800 may take various different forms. For example, computer system 800 may be embodied as a tablet, a desktop, a laptop, a mobile device, or a standalone device, such as those described throughout this disclosure. Computer system 800 may also be a distributed system that includes one or more connected computing components/devices that are in communication with computer system 800.

In its most basic configuration, computer system 800 includes various different components. FIG. 8 shows that computer system 800 includes one or more processor(s) 805 (aka a “hardware processing unit”) and storage 810.

Regarding the processor(s) 805, it will be appreciated that the functionality described herein can be performed, at least in part, by one or more hardware logic components (e.g., the processor(s) 805). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 800. The different components, modules, engines, and services described herein may be implemented as objects or processors that execute on computer system 800 (e.g. as separate threads).

Storage 810 may be physical system memory, which may be volatile, non-volatile, or some combination of the two. The term “memory” may also be used herein to refer to non-volatile mass storage such as physical storage media. If computer system 800 is distributed, the processing, memory, and/or storage capability may be distributed as well.

Storage 810 is shown as including executable instructions 815. The executable instructions 815 represent instructions that are executable by the processor(s) 805 of computer system 800 to perform the disclosed operations, such as those described in the various methods.

The disclosed embodiments may comprise or utilize a special-purpose or general-purpose computer including computer hardware, such as, for example, one or more processors (such as processor(s) 805) and system memory (such as storage 810), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 800 may also be connected (via a wired or wireless connection) to external sensors (e.g., one or more remote cameras) or devices via a network 820. For example, computer system 800 can communicate with any number devices or cloud services to obtain or process data. In some cases, network 820 may itself be a cloud network. Furthermore, computer system 800 may also be connected through one or more wired or wireless networks to remote/separate computer systems(s) that are configured to perform any of the processing described with regard to computer system 800.

A “network,” like network 820, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 800 will include one or more communication channels that are used to communicate with the network 820. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
at a computing system, using network crawling to identify a plurality of example query expressions stored at various different locations on a network, the example query expressions in the plurality of example query expressions having one or more specific data access functions, specific data analytics functions, or specific data enrichment functions, and having specific arguments;
storing the plurality of example query expressions in storage at the computing system;
transmitting, over a network connection the example query expressions to a large language model system;
providing from the computing system, over the network connection, a centrally managed ontology to the large language model system;
receiving from the large language model system, a plurality of annotated skills, the annotated skills in the plurality of annotated skills being genericized versions of example query expressions in the plurality of example query expressions, the annotated skills comprising skill ontological types genericized from entities the example query expressions in the plurality of example query expressions, the skill ontological types being related to at least one of input arguments to the annotated skills or structured output of the annotated skills, the skill ontological types being normalized to the centrally managed ontology;
using the skill ontological types, storing an ontologically typed graph having skills in the plurality of skills coupled to each other through in-common, normalized, ontological types;
providing, over the network connection, at least a portion of the plurality of the annotated skills in the ontologically typed graph to the large language model system; and
receiving over the network, from the large language model system a message indicating an investigation skill to be invoked.

2. The method of claim 1, further comprising:
providing context to the large language model system;
receiving from the large language model system a context ontological type, the context ontological type being normalized to the centrally managed ontology;
using the context ontological type, pruning the ontologically typed graph to store a pruned graph.

3. The method of claim 2, wherein providing context to the large language model system comprises providing an initial context and investigation goal to the large language model system.

4. The method of claim 2, wherein providing at least a portion of the plurality of annotated skills in the ontologically typed graph is performed by providing the pruned graph, and wherein the investigation skill to be invoked is from the pruned graph.

5. The method of claim 2, further comprising:
invoking a skill; and
wherein providing context to the large language model system comprises providing a context created as a result of invoking the skill.

6. The method of claim 1, wherein the plurality of example query expressions comprises functionality for generating a log.

7. A method comprising:
at a large language model system, consuming a plurality of example query expressions, the example query expressions in the plurality of example query expressions comprising one or more specific data access functions, specific data analytics functions, or specific data enrichment functions, and having specific arguments;
at the large language model system receiving a centrally managed ontology;
the large language model system identifying skill ontological types from the example query expressions, the skill ontological types being related to at least one of input arguments or structured output, the skill ontological types being normalized to the centrally managed ontology, and genericized;
the large language model system generating a plurality of annotated skills, the annotated skills in the plurality of annotated skills being genericized versions the example query expressions, the annotated skills comprising skill ontological types genericized from query expression;
the large language model system providing the plurality of annotated skills, over a network connection, to an external computing system;
the large language model system receiving context for an investigation;
the large language model system identifying a context ontological type from the context, using the centrally managed ontology;
the large language model providing the context ontological type to the computing system, over the network connection;
the large language model system receiving received skills, from the plurality of annotated skills, over the network, from the computing system, based on correlation between a skill ontological type and the context ontological type; and
as a result, the large language model system, using the trained model, producing and providing a message of a suggested skill for the investigation.

8. The method of claim 7, wherein receiving context for the investigation; identifying the context ontological type from the context; receiving received skills; and providing an indication of suggested skills for the investigation are performed recursively.

9. The method of claim 7, further comprising receiving a schema, and wherein generating a plurality of annotated skills is performed using the schema.

10. The method of claim 7, the large language model system receiving an investigation goal, and wherein providing the indication of the suggested skill for the investigation is performed using the investigation goal.

11. The method of claim 7, wherein at least one of the plurality of example query expressions is configured to generate a log.

12. The method of claim 7, wherein at least one of the plurality of example query expressions is configured to generate a table.

13. The method of claim 7, wherein at least one of the plurality of example query expressions is configured to generate a database view.

14. The method of claim 7, wherein at least one of the plurality of example query expressions is configured to invoke an API skill.

15. The method of claim 7, wherein providing an indication of the suggested skill for the investigation comprises providing an indication of a combined query comprising a plurality of skills invoked together.

16. The method of claim 7, wherein identifying the skill ontological types or the context ontological type comprises adapting native ontological types to normalize the skill ontological types to the centrally managed ontology.

17. The method of claim 7, further comprising performing a shortest path analysis, and wherein providing an indication of the suggested skill for the investigation comprises providing an indication of a skills identified in the shortest path analysis.

18. A computing system comprising:
a processor; and
computer-readable media having stored thereon instructions that are executable by the processor to configure the computer system to normalize ontological types in skills and to automatically receive skill recommendation messages, including instructions that are executable to configure the computer system to perform at least the following:
at the computing system, network crawling to identify a plurality of example query expressions stored at various different locations on a network, the example query expressions in the plurality of example query expressions having one or more specific data access functions, specific data analytics functions, or specific data enrichment functions, and having specific arguments;
store the plurality of example query expressions in storage at the computing system;
transmit, over a network connection the example query expressions to a large language model system;
provide from the computing system, over the network connection, a centrally managed ontology to the large language model system;
receive from the large language model system, a plurality of annotated skills, the annotated skills in the plurality of annotated skills being genericized versions of example query expressions in the plurality of example query expressions, the annotated skills comprising skill ontological types genericized from entities the example query expressions in the plurality of example query expressions, the skill ontological types being related to at least one of input arguments to the annotated skills or structured output of the annotated skills, the skill ontological types being normalized to the centrally managed ontology;
use the skill ontological types, storing an ontologically typed graph having skills in the plurality of skills coupled to each other through in-common, normalized, ontological types;
provide, over the network connection, at least a portion of the plurality of the annotated skills in the ontologically typed graph to the large language model system;
receive over the network, from the large language model system a message indicating an investigation skill to be invoked.

19. The system of claim 18, the computer-readable media further having stored thereon instructions that are executable by the processor to configure the computer system to:
provide context to the large language model system;
receive from the large language model system a context ontological type, the context ontological type being normalized to the centrally managed ontology;
use the context ontological type and prune the ontologically typed graph to store a pruned graph.

20. The system of claim 18, wherein providing context to the large language model system comprises providing an initial context and investigation goal to the large language model system.
